(19) United States
(12) Patent Application Publication
(10) Pub. No.: US 2012/0162128 A1
(43) Pub. Date: Jun. 28, 2012

(54) TOUCH INPUT DEVICE AND ELECTROMAGNETIC-WAVE TRANSCEIVER USING THE SAME DEVICE

(75) Inventors: Chang Hee HYOUNG, Daejeon (KR); Sung Weon Kang, Daejeon (KR); In Gi Lim, Daejeon (KR); Hyung-IL Park, Daejeon (KR); Tae Wook Kang, Daejeon (KR); Jung Hwan Hwang, Daejeon (KR); Kyungsoo Kim, Daejeon (KR); Jung Burn Kim, Daejeon (KR); Sung Eun Kim, Seoul (KR); Kyung Hwan Park, Daejeon (KR); Byoung Gun Choi, Daegu (KR); Tae Young Kang, Seoul (KR); Jin Kyung Kim, Daejeon (KR)

(73) Assignee: Electronics and Telecommunications Research Institute, Daejeon (KR)

(21) Appl. No.: 13/326,164

(22) Filed: Dec. 14, 2011

(30) Foreign Application Priority Data
Dec. 23, 2010 (KR) 10-2010-0134055

(51) Int. Cl. G06F 3/045; G06F 3/041

(52) U.S. Cl. 345/174; 345/173

(57) ABSTRACT

A touch input device includes: a transparent electrode includes: a plurality of unit electrodes; a switch configured to reconfigure an electrical connection state of the transparent electrode; and a controller configured to control the switch that reconfigures the electrical connection state of the transparent electrode.

### CROSS-REFERENCES TO RELATED APPLICATIONS

The present application claims priority under 35 U.S.C 119(a) to Korean Application No. 10-2010-0134055, filed on Dec. 23, 2010 in the Korean intellectual property Office, which is incorporated herein by reference in its entirety set forth in full.

### BACKGROUND

Exemplary embodiments of the present invention relate to a touch input device, and more particularly, to a touch input device which is capable of transmitting and receiving an electrical signal to and from the outside through a transparent electrode used in a touch screen, and an electromagnetic-wave transceiver using the same touch screen device.

Conventionally, an antenna capable of transmitting and receiving an electromagnetic signal to and from a plurality of transparent electrodes composing a touch screen has been independently configured. The plurality of transparent electrodes composing the touch screen may be formed of a material which has excellent light transmission and combined with a display device so as to provide an image to a user. Furthermore, the transparent electrodes may be formed of a material which has conductivity to recognize a user's touch.

In order to sense a user's touch through a capacitance change, self-capacitance and mutual capacitance touch input devices are representatively used.

Furthermore, an antenna which is representatively used as an element for transmitting and receiving an electromagnetic signal is usually manufactured by using a metallic material or a metal pattern formed on the surface of a dielectric material.

### SUMMARY

An embodiment of the present invention relates to a touch input device capable of transmitting and receiving an electrical signal to and from the outside through a transparent electrode used in a touch screen and an electromagnetic-wave transceiver using the same.

Another embodiment of the present invention relates to a structure which is configured with a display device and transmits and receives an electromagnetic signal to and from the outside through a conductive electrode which is required to receive various types of inputs such as a user's selection and movement among contents displayed to a user, using a common characteristic of a touch screen and an antenna.

In one embodiment, a touch input device includes: a transparent electrode includes: a plurality of unit electrodes; a switch configured to reconfigure an electrical connection state of the transparent electrode; and a controller configured to control the switch that reconfigures the electrical connection state of the transparent electrode.

The touch input device may further include a transceiver electrically connected to the transparent electrode and configured to transmit and receive a wireless radio frequency signal through the transparent electrode.

The controller may control electrical connection states between the respective unit electrodes such that the transparent electrode is used to perform beam forming, when the transceiver transmits and receives a wireless radio frequency signal through the transparent electrode.

The controller may control electrical connection states between the respective unit electrodes such that a wireless radio frequency signal is transmitted and received through a transparent electrode segment having a length required for transmitting and receiving the wireless radio frequency signal.

The touch input device may further include a driving circuit and a sensing circuit which are electrically connected to the transparent electrode so as to receive a touch input signal.

The touch input device may include a self-capacitance touch panel.

The touch input device may include a mutual capacitance touch panel.

In another embodiment, an electromagnetic-wave transceiver using a touch input device includes: a transparent electrode comprising a plurality of unit electrodes; a switch configured to reconfigure an electrical connection state of the transparent electrode; a controller configured to control the switch that reconfigures the electrical connection state of the transparent electrode; and a transceiver electrically connected to the transparent electrode and configured to transmit and receive a wireless radio frequency signal through the transparent electrode.

The controller may control the switch that reconfigures electrical connection states between the respective unit electrodes, in order to transmit and receive a wireless radio frequency signal through the transceiver.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram explaining the operation principle of a general capacitive touch input device;

FIGS. 2A and 2B are diagrams explaining the layer arrangement and configuration of a general touch input device;

FIG. 3 illustrates a general dipole antenna;

FIG. 4 illustrates a general patch array antenna;

FIGS. 5A and 5B are diagrams explaining a touch input device and an electromagnetic-wave transceiver using the same in accordance with an embodiment of the present invention;

FIGS. 6A and 6B are diagrams explaining a touch input device and an electromagnetic-wave transceiver using the same in accordance with another embodiment of the present invention; and

FIG. 7 is a diagram explaining a portable user device to which the touch input device in accordance with the embodiment of the present invention is applied.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

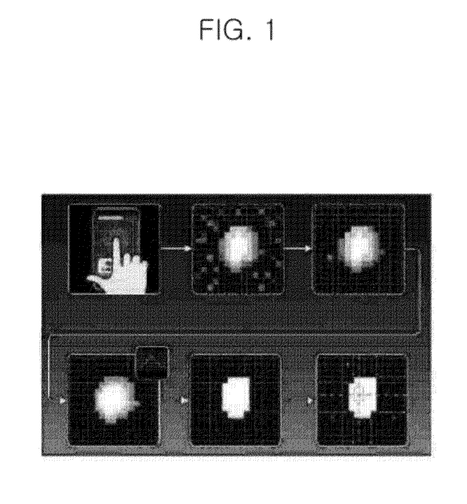

FIG. 1 is a diagram explaining the operation principle of a general capacitive touch input device. Although not perceived by a user, a plurality of transparent electrodes for recognizing a user's touch are formed over a display.

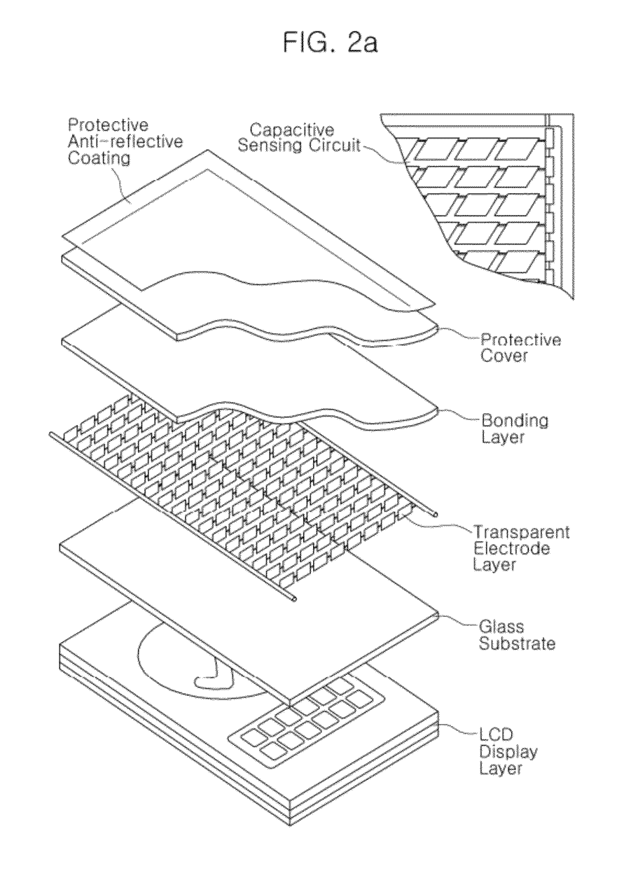

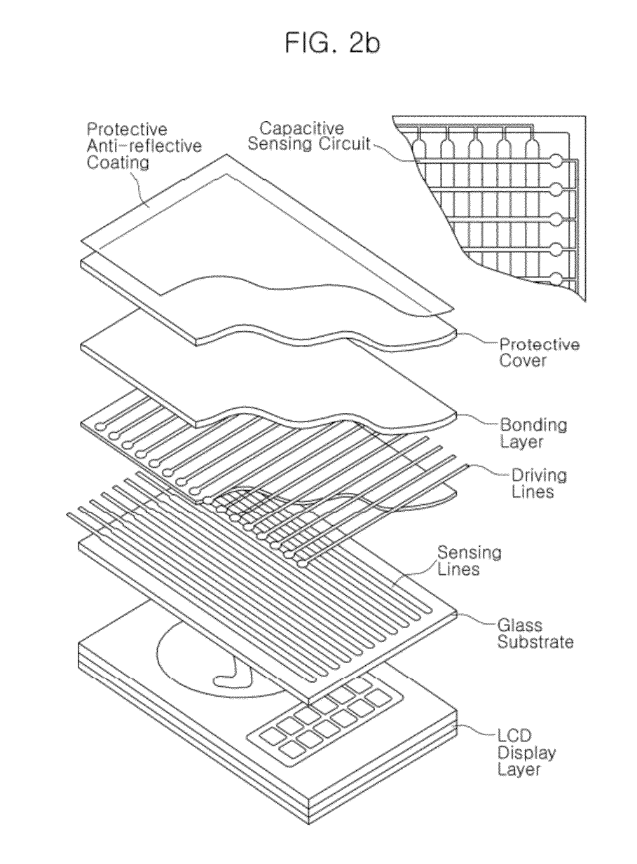

FIG. 2A is a diagram of an electrode configuration to perform a multi-touch function, illustrating the layer arrangement and configuration of a self-capacitance touch input device. FIG. 2B is a diagram of an electrode configuration to perform a multi-touch function, illustrating the layer arrangement and configuration of a mutual-capacitance touch input device.

Referring to FIGS. 2A and 2B, a plurality of conductive electrodes are arranged on the entire surface of a touch screen.

Currently, such electrodes are used only as an input unit for receiving a user's selection by analyzing a capacitance component which is changed when a user's touch is performed.

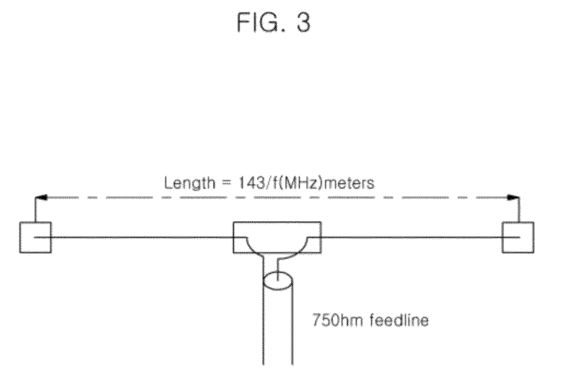

FIG. 3 illustrates a general dipole antenna having a length proportional to the wavelength of a frequency which is to be used.

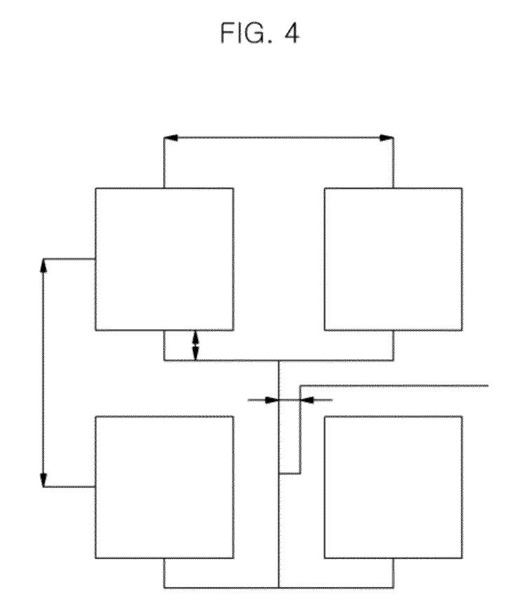

FIG. 4 illustrates a general patch array antenna. Transparent electrodes forming the self-capacitance touch input device of FIG. 2A basically have the shape of a patch antenna, and transparent electrodes forming the mutual capacitance touch input device of FIG. 2B have the shape of a dipole antenna. The transparent electrodes are transparent but have conductivity.

Using such characteristics, an antenna for wireless communication may be configured by adding a control circuit to a touch screen which is manufactured through a semiconductor process.

An antenna used in a mobile phone may support a variety of wireless communication technologies in various bands, such as 1.9 GHz mobile phone, 2.4 GHz Bluetooth and WLAN, and 5.8 GHz WLAN. Accordingly, a plurality of antennas is required. The current trend of mobile phones is towards smart phones, and a variety of mobile terminals such as tablet PCs have been recently launched on the market. Most of the mobile terminals employ a touch screen which supports a multi-touch to implement an intuitive interface, and includes a plurality of transparent electrodes described in this specification.

Basically, transparent electrodes composing a touch screen are formed with a minute size through a semiconductor process such that a user's touch is better recognized. In order to form a desired antenna using such transparent electrodes, interconnections for connecting the respective transparent electrodes at a desired size are required. Referring to FIGS. 2A and 2B, basic interconnections are provided, and switches for combining the interconnections and control circuits for controlling the switches are additionally provided. Such circuits may be positioned at an edge of the display so as not to interfere with the visibility of a user.

Through such a combination of interconnections, antennas operating in various frequency bands may be controlled in a software manner. Furthermore, antennas operating in the same band may be configured in an array form to increase an antenna gain in an area where reception is low. Currently, displays of mobile terminals having a communication function have various sizes from 3 inch to 10 inch. However, although the smallest display is used, a combination of antennas operating in various bands including a low-frequency communication may be implemented when transparent electrodes included in a 3-inch touch screen are used.

Such an antenna form may implement most of antennas which are formed in a patch or dipole type, through a combination of electrodes as illustrated in FIG. 3 or 4. A phase array or beam forming which may be obtained by using a plurality of antenna may be implemented through a control circuit.

In the case of a touch screen using a self capacitor, electrodes are formed in a rectangular shape. Therefore, various types of combinations may be implemented through a one-dimension connection and a two-dimensional connection. In the case of a touch screen using a mutual capacitor, electrodes are formed in a line shape, and interconnections are arranged in one side of the touch screens. Therefore, it is difficult to implement various types of combinations. However, when interconnections are arranged in both sides, one line is divided into two parts, and combinations are configured with various lengths, it is possible to obtain antennas with various lengths through a control circuit. Furthermore, it is possible to implement an array.

When such a method is used, a filter and matching circuit for smoothly transmitting a signal as well as an antenna may be implemented. When a high-frequency circuit design principle is used, transparent electrodes manufactured to obtain a capacitor may be used as an inductor by a combination through a control circuit. The characteristics of the capacitor and the inductor may be used to implement a filter and an impedance matching circuit.

When such a concept is expanded, a touch screen may be expanded into an interface of a signal as well as a user's input. When a wireless communication using a new frequency appears, a modem and a radio frequency (RF) module may be configured in a hardware manner through a memory slot of a mobile terminal, and a new antenna may be configured through a plurality of electrodes existing in the touch screen. Accordingly, as the expandability of the mobile terminal increases, the mobile terminal may be used as one platform.

For example, when a chip having an RFID function built therein is mounted in a memory slot and a USIM card of a mobile phone having no RFID payment function and an antenna is formed in a display of a mobile phone through a connection of electrodes, a new service may be used without replacing the mobile phone.

In order to implement such a structure, the electrodes of the touch screen may be used together. In this case, however, an electrical capacity may be changed during signal transmission, thereby causing a malfunction. Therefore, an off-set control circuit for correcting the change may be added. Furthermore, between the respective transparent electrodes for the touch screen, electrodes for signal transmission may be configured at the same layer.

Furthermore, as the antenna and electrodes for signal transmission are disposed in an area which has not been used, such as the edge of a mobile terminal, except a display area, the above-described function may be stably implemented without the interference between two functions.

Recently, a variety of wireless power transfer techniques have been applied to mobile devices. Such techniques use a magnetic field to transfer power, while having a small effect upon the human body. For this operation, power transfer devices require a coil. A coil for wireless power transfer may be configured by using a reconfigurable electrode or the like. Furthermore, a pattern for the coil may be formed at the edge of a mobile device.

The above-described communication technology, a non-contact service based on wireless communication has been described. However, a contact service or a near-field communication within several cm may be used in the form of an electrode.

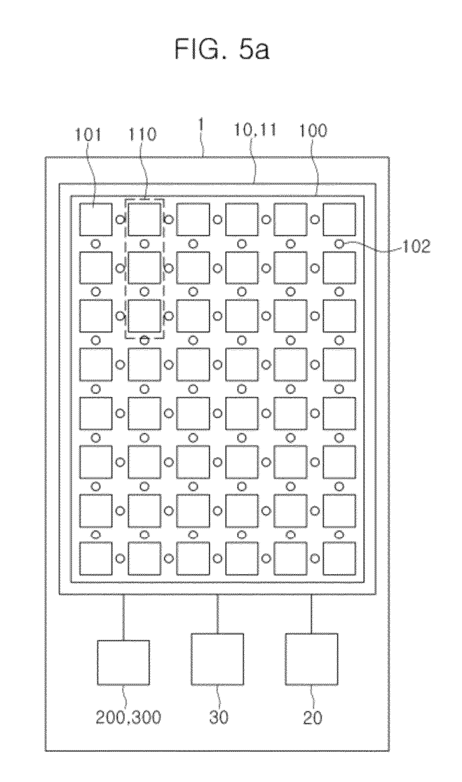

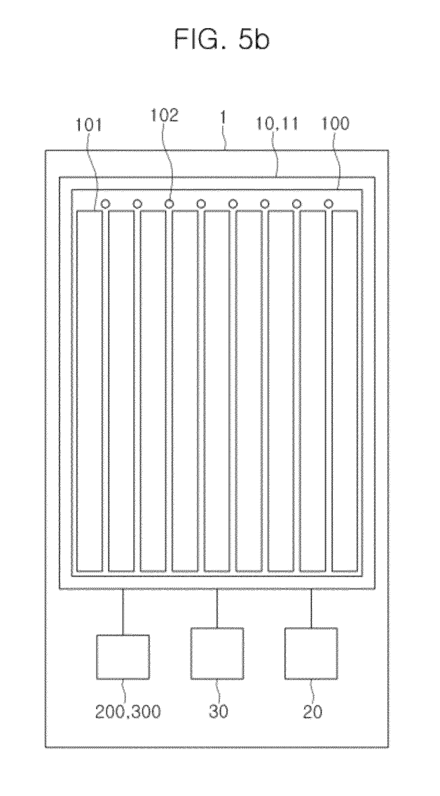

FIGS. 5A and 5B are diagrams explaining a touch input device and an electromagnetic-wave transceiver using the same in accordance with an embodiment of the present invention.

The touch input device includes a capacitive touch input panel 10 and a transceiver 20. The touch input panel 10 includes a transparent electrode 100. The transceiver 20 is electrically connected to the transparent electrode 100 so as to transmit and receive a wireless radio frequency signal through the transparent electrode 100.

At this time, the touch input panel 10 may include a self-capacitance touch panel 11 as illustrated in FIG. 5A and a mutual-capacitance touch panel 12 as illustrated in FIG. 5B.

Referring to FIG. 5A, when the touch input panel 10 is the self-capacitance touch panel 11, the transparent electrode 100 includes a plurality of unit electrodes 101 arranged in a matrix shape. A wireless mobile communication device 1 may include a controller 30 configured to control the switche that changes the electrical connection states between the respective unit electrodes 101 such that the transparent electrode 100 is used to perform beam forming, when the transceiver 20 transmits and receives a wireless radio frequency signal through the transparent electrode 100.

Referring to FIG. 5B, when the touch input panel 10 is the mutual capacitance touch panel 12, the transparent electrode 100 includes a plurality of unit electrodes 101. The wireless mobile communication device 1 may include a controller 30 configured to control the switche that changes the electrical connection states between the respective unit electrodes 101 such that the transparent electrode 100 is used to perform beam forming, when the transceiver 20 transmits and receives a wireless radio frequency signal through the transparent electrode 100. For convenience of description, FIG. 5B illustrates only the transparent electrode 100 which is extended in a longitudinal direction on one surface of an insulation substrate. However, the wireless mobile communication device 1 may further include a transparent electrode which is extended in a widthwise direction on the other surface of the insulation surface.

At this time, the electrical connection states between the respective unit electrodes 101 may be controlled by turning on/off switches 102 between the unit electrodes 101. Furthermore, an analog front end of the transceiver 20 may be connected to one or more unit electrodes 101.

Alternatively, the transparent electrode 100 may include a plurality of unit electrodes 101, and the wireless mobile communication device 1 may include a controller 30 configured to control the switche that changes the electrical connection states between the respective unit electrodes 101 such that a wireless radio frequency signal is transmitted and received through a transparent electrode segment 110 having a length required for transmitting and receiving a wireless radio frequency signal. For example, referring to FIG. 5A, only three unit electrodes 101 may be electrically connected to form the transparent electrode segment 110, and the transceiver 20 may apply a high-frequency wireless communication signal to the segment 110, or a high-frequency wireless communication signal received through the segment 110 may be inputted to the transceiver 20. That is, the segment 110 which is a part of the transparent electrode 100 may serve as a high-frequency signal antenna. However, the present invention is not limited to such an example, and the length and shape of the segment may be set in various manners depending on combinations of the unit electrodes 101.

The transceiver 20 and the controller 30 may be implemented in one chip or different chips.

Furthermore, the wireless mobile communication device 1 may further include a driving circuit 200 and a sensing circuit 300 which are electrically connected to the transparent electrode 100 so as to receive a touch input signal.

The driving circuit 200 and the sensing circuit 300 may be integrally implemented in one chip or independently implemented in different chips. The touch input panel 10, the driving circuit 200, and the sensing circuit 300 for receiving a touch input may be configured according to the existing well-known technology.

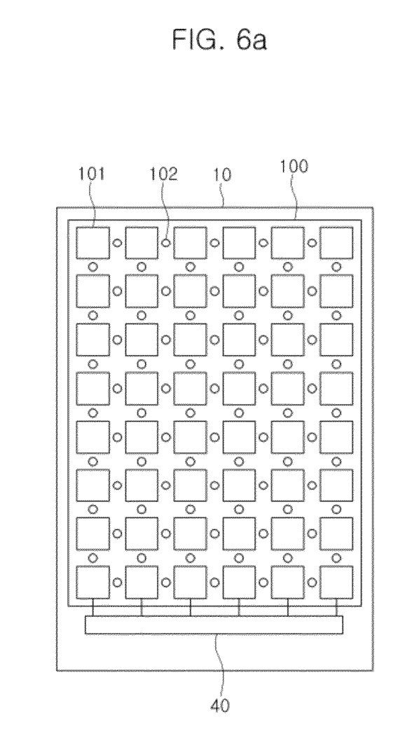

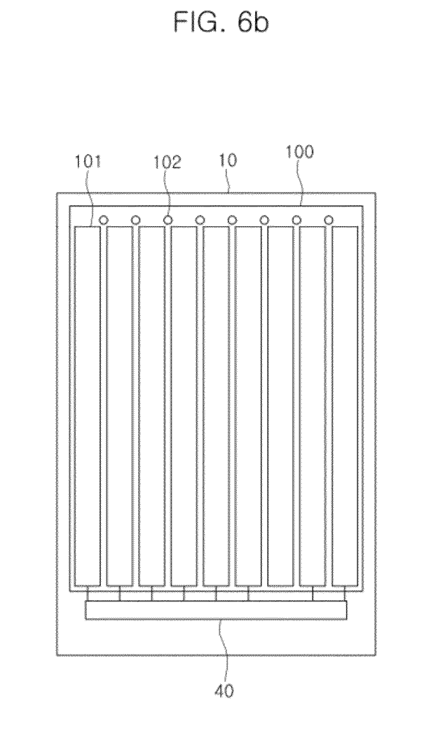

FIGS. 6A and 6B are diagrams explaining a touch input device and an electromagnetic-wave transceiver using the same in accordance with another embodiment of the present invention.

Referring to FIGS. 6A and 6B, a touch input device includes an interface 40 capable of connecting a transceiver to a transparent electrode 100. FIGS. 6A and 6B illustrate that the interface 40 is directly connected to the unit electrodes 101 of the transparent electrode 100, but a plurality of switches may be interposed between the interface 40 and the respective unit electrodes 101.

The transparent 100 includes a plurality of unit electrodes 101, and a touch input panel 10 includes one or more switches 102 which are used for reconfiguring the electrical connection states between the respective unit electrodes 101. The transparent electrode 100 may be connected to a controller of a wireless mobile communication device, which controls the operation states of the switche 102, through the interface 40.

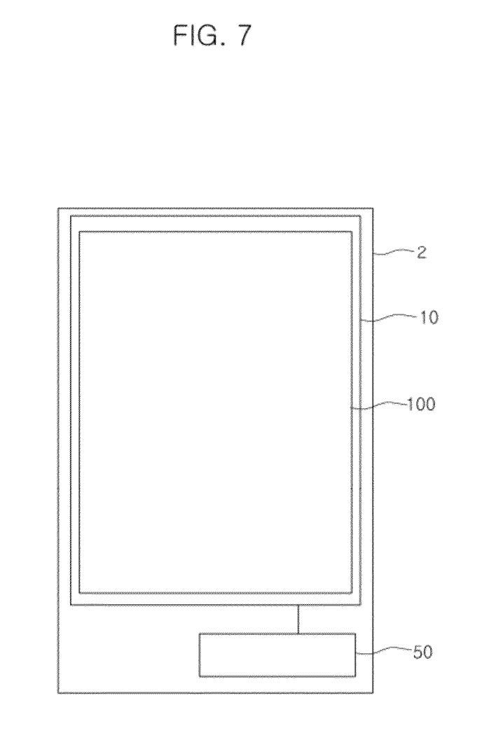

Referring to FIG. 7, a portable user device in accordance with another embodiment of the present invention will be described.

The portable user device 2 is a portable user device including a capacitive touch input panel 10 having a transparent electrode 100, and includes a charger 50 which is electrically connected to the transparent electrode 100 so as to receive an RF power signal through the transparent electrode 100. The touch input panel 10 may be configured in the same manner as illustrated in FIG. 5A, 5B, 6A, or 6B. The charger 50 may include a power converter configured to receive an RF power signal through the transparent electrode 100 and convert the received RF power signal into a storable signal and/or a battery.

Hereinafter, a user device in accordance with another embodiment of the present invention will be described. The user device includes a capacitive touch input panel having a transparent electrode. At this time, the user device may further include an electromagnetic-wave transceiver which is electrically connected to the transparent electrode so as to wirelessly transmit and receive an electromagnetic wave through the transparent electrode. A specific example of the user device in accordance with the embodiment of the present invention may include the wireless mobile communication device described with reference to FIG. 5.

In accordance with the embodiment of the present invention, since the plurality of transparent electrodes used for constructing a touch screen may be used to implement a reconfigurable antenna, existing antennas operating in various bands may be replaced, a gain may be obtained through a combination of antennas operating in the same band, and a phase array or beam forming may be implemented. Furthermore, an antenna which may be reconfigured through software may be used to conveniently apply a new communication technology to an existing device.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A touch input device comprising:
a transparent electrode having a plurality of unit electrodes;
a switch configured to reconfigure an electrical connection state of the transparent electrode; and
a controller configured to control the switch that reconfigures the electrical connection state of the transparent electrode.

2. The touch input device of claim 1, further comprising a transceiver electrically connected to the transparent electrode and configured to transmit and receive a wireless radio frequency signal through the transparent electrode.

3. The touch input device of claim 1, wherein the controller controls electrical connection states between the respective unit electrodes such that the transparent electrode is used to perform beam forming, when the transceiver transmits and receives a wireless radio frequency signal through the transparent electrode.

4. The touch input device of claim 1, wherein the controller controls electrical connection states between the respective unit electrodes such that a wireless radio frequency signal is transmitted and received through a transparent electrode segment having a length required for transmitting and receiving the wireless radio frequency signal.

5. The touch input device of claim 1, further comprising a driving circuit and a sensing circuit which are electrically connected to the transparent electrode so as to receive a touch input signal.

6. The touch input device of claim 1, wherein the touch input device comprises a self-capacitance touch panel.

7. The touch input device of claim 1, wherein the touch input device comprises a mutual capacitance touch panel.

8. An electromagnetic-wave transceiver using a touch input device, comprising:
a transparent electrode having a plurality of unit electrodes;
a switch configured to reconfigure an electrical connection state of the transparent electrode;
a controller configured to control the switch that reconfigures the electrical connection state of the transparent electrode; and
a transceiver electrically connected to the transparent electrode and configured to transmit and receive a wireless radio frequency signal through the transparent electrode.

9. The electromagnetic-wave transceiver of claim 8, wherein the controller controls the switch that reconfigures electrical connection states between the respective unit electrodes, in order to transmit and receive a wireless radio frequency signal through the transceiver.
